(19) United States
(12) Patent Application Publication
(10) Pub. No.: US 2026/0201199 A1
(43) Pub. Date: Jul. 16, 2026

(54) TWO-LAYER COATINGS FOR IMPROVED CORROSION RESISTANCE AND HARDNESS

(71) Applicant: Rohm and Haas Company, Collegeville, PA (US)

(72) Inventors: Denise Lindenmuth, Ambler, PA (US); Zhenwen Fu, Norristown, PA (US); Andrew Hejl, Lansdale, PA (US)

(21) Appl. No.: 19/139,334

(22) PCT Filed: Dec. 11, 2023
(86) PCT No.: PCT/US2023/083276

§ 371 Date: Jun. 14, 2025

Related U.S. Application Data
(60) Provisional application No. 63/433,918, filed on Dec. 20, 2022.

(51) Int. Cl. C09D 133/04; B05D 1/38; B05D 3/02; B05D 7/00; C09D 125/14; C09D 163/00

(52) U.S. Cl. CPC C09D 133/04; B05D 1/38; B05D 3/0254; B05D 7/544; C09D 125/14; C09D 163/00

(57) ABSTRACT

The present invention relates to a coating system comprising a first two-component waterborne coating composition comprising a binder component 1A and a curing component 1B and a second two-component waterborne coating composition comprising a binder component 2A and a curing component 2B. The first two-component waterborne coating composition comprises a first coalescent package comprising at least one coalescent and has a minimum film formation temperature less than 5° C. The second two-component waterborne coating composition comprises a second coalescent package comprising at least one coalescent and has a minimum film formation temperature from 5° C. to 25° C. A method of preparing a coating is also disclosed.

### BACKGROUND OF THE INVENTION

In the coatings industry, especially the industrial coatings industry, coatings having both corrosion and weather resistance are often desired. Multiple layer coatings were developed to provide a first layer providing adhesion and corrosion resistance to the substrate. Additional layers were then applied to provide weather resistance, chemical resistance, and/or the desired appearance. Epoxy resins were generally selected for the first layer, while polyurethane resins or acrylic resins were often used for the upper layer(s). Different resin chemistries were used due to the difficulty of finding a single resin chemistry that provided the necessary balance between corrosion resistance and weather resistance.

Acrylic epoxy hybrid (AEH) resins, such as that disclosed in U.S. Pat. No. 8,658,742, were developed to provide a better balance between corrosion resistance and weather resistance in a single-chemistry system. These AEH resin systems allowed for one-coating systems that provided good corrosion resistance and weather resistance for many applications, such as in direct to metal coatings.

However, for some applications, the hardness and/or weatherability provided by existing AEH resin systems is not adequate. There is a desire for a low cost and simple resin system, such as a single-chemistry system, that can provide the desired corrosion resistance, weatherability, and hardness.

### SUMMARY OF THE INVENTION

In a first aspect, the present invention relates to a coating system comprising:
a) a first two-component waterborne coating composition comprising a binder component 1A and a curing component 1B, wherein the binder component 1A comprises a first aqueous dispersion of acrylic polymer particles imbibed with an epoxy compound, wherein the first two-component waterborne coating composition comprises a first coalescent package comprising at least one coalescent and has a minimum film formation temperature (MFFT) less than 5° C.;
b) a second two-component coating composition comprising a binder component 2A and a curing component 2B, wherein the binder component 2A comprises a second aqueous dispersion of acrylic polymer particles imbibed with an epoxy compound, wherein the second two-component waterborne coating composition comprises a second coalescent package comprising at least one coalescent and has a minimum film formation temperature (MFFT) from 5° C. to 25° C.

In a second aspect, the present invention relates to a method of preparing a coating comprising:
(i) providing a coating system of any one of the preceding claims;
(ii) applying the first two-part coating composition to a substrate to form a first coating layer;
(iii) at least partially curing the first coating layer at a temperature greater than room temperature for at least 10 minutes;
(iv) applying the second two-part coating composition on the first coating layer to form a second coating layer;
(v) curing the second coating layer to form a two-layer coating on the substrate at a temperature.

### BRIEF DESCRIPTION OF THE DRAWINGS

FIG. 1 is a photograph of coatings according to embodiments of the present invention and comparative examples subjected to salt spray to determine corrosion resistance.

FIG. 2 is a photograph of coatings according to comparative examples subjected to salt spray to determine corrosion resistance.

### DETAILED DESCRIPTION OF THE INVENTION

In a first aspect, the present invention relates to a coating composition comprising a first two-component waterborne coating composition and a second two-component waterborne coating composition.

The first two-component waterborne coating composition comprises a binder component 1A and a curing (i.e., crosslinking) component 1B. The binder component 1A comprises a first aqueous dispersion of acrylic polymer particles imbibed with an epoxy compound. As used herein, the term “acrylic” includes (meth)acrylic acid, (meth)alkyl acrylate, (meth)acrylamide, (meth)acrylonitrile and their modified forms such as (meth)hydroxyalkyl acrylate. The fragment “(meth)acryl” refers to both “methacryl” and “acryl,” such as, for example, (meth)acrylic acid referring to both methacrylic acid and acrylic acid and methyl (meth)acrylate referring to both methyl methacrylate and methyl acrylate. As used herein, the term “imbibed with an epoxy compound” means that the epoxy compound is absorbed at least in part by the acrylic polymer particles, but not reacted with the acrylic polymer particles, and is not merely present on the surface of the acrylic polymer particles.

The second two-component waterborne coating composition comprises a binder component 2A and a curing component 2B. The binder component 2A comprises a second aqueous dispersion of acrylic polymer particles imbibed with an epoxy compound.

The first and second aqueous dispersions of acrylic polymer particles imbibed with an epoxy compound may be the same or different. Preferably, the first and second aqueous dispersions of acrylic polymer particles imbibed with an epoxy compound are the same.

Preferably, the first and second aqueous dispersions of acrylic polymer particles imbibed with an epoxy compound comprise aqueous dispersions of acrylic polymer particles imbibed with a thermosettable compound having at least two oxirane groups. As used herein, the term “thermosettable compound” means a compound that will undergo a chemical reaction to form a thermoset compound which has different chemical and physical properties and does not undergo a reversible thermal transition when exposed to heat.

The imbibed thermosettable compound preferably has a multiplicity of oxirane groups; more preferably, the thermosettable compound is a novolac resin, a di-, tri- or tetraglycidyl ether or a di-, or tri- or tetraglycidyl ester.

Examples of suitable thermosettable compounds include the diglycidyl ether of bisphenol A, the diglycidyl ether of bisphenol F, 1,4-butanediol diglycidyl ether, 1,6-hexanediol diglycidyl ether, the diglycidyl ester of phthalic acid, 1,4-cyclohexanedmethanol diglycidyl ether, 1,3-cyclohexanedmethanol diglycidyl ether, the diglycidyl ester of hexahydrophthalic acid, and novolac resins, and combinations thereof. A commercially available thermosettable compound is D.E.R.331 Liquid Epoxy Resin (available from Olin Corporation).

Aqueous dispersions of the acrylic polymer particles (i.e., latexes) can be achieved through free radical emulsion or suspension addition polymerization or by dispersion of a pre-formed polymer under shear into an aqueous medium. Examples of suitable latexes include acrylic and styrene-acrylic based latexes.

The acrylic polymer particles may further contain anti-agglomerating functional groups, which refer to hydrophilic groups that are sufficiently unreactive with the oxirane groups (and ester groups, if present) such that the latex particles are heat-age stable at 60° C. for 10 days. The term “heat-age stable at 60° C. for 10 days” is used herein to mean that the particle size of a latex subjected to heat-aging at 60° C. for 10 days stability does not increase by more than 30% beyond the particle size before such heat-age studies.

Anti-agglomerating functional groups can be incorporated into the polymer particles using monomers containing anti-agglomerating functional groups (anti-agglomerating monomers), although it would also be possible to incorporate such groups by grafting. The anti-agglomerating groups are believed to be effective because they are hydrophilic as well as non-reactive with oxirane groups under heat-age conditions. The general class of such groups includes amide groups, acetoacetoxy groups, and strong protic acids, which are pH adjusted to form their conjugate bases.

Specific examples of anti-agglomerating monomers include acrylamide, phosphoethyl methacrylate, sodium styrene sulfonate, acetoacetoxyethyl methacrylate, and acrylamido-methyl-propane sulfonate. When present, the concentration of anti-agglomerating functional groups in the polymer is preferably sufficient to stabilize the thermoplastic polymer under heat-age conditions, preferably from 0.5, and more preferably from 1, to preferably 10, and more preferably to 5 weight percent, based on the weight of the polymer.

Monomers suitable for the preparation of acrylic latexes include acrylates and methacrylates such as methyl acrylate, ethyl acrylate, butyl acrylate, 2-ethylhexyl acrylate, methyl methacrylate, ethyl methacrylate, butyl methacrylate, and 2-ethylhexyl methacrylate, and combinations thereof. Furthermore, the acrylic latexes may also include structural units of other monomers such as styrene and acrylonitrile. As used herein, the term “structural units” refers to the remnant of a named monomer after polymerization. Structural units of one or more acid monomers may also be included, most notably acrylic acid, methacrylic acid, and itaconic acid. Monomers capable of imparting co-curable functionality such as glycidyl acrylates and methacrylates may also be included.

It may be advantageous to include chain transfer agents in the latex preparation. Examples of chain transfer agents include, but are not limited to, dodecylmercaptan, butylmercaptopropionate, methylmercaptopropionate, mercaptopropionic acid, etc.

In certain embodiments it may be advantageous to incorporate into the polymer copolymerized multi-ethylenically unsaturated monomer groups. Multi-ethylenically unsaturated monomers include, for example, allyl (meth)acrylate, diallyl phthalate, 1,4-butylene glycol di(meth)acrylate, 1,2-ethylene glycol di(meth)acrylate, 1,6-hexanediol di(meth)acrylate, and divinyl benzene. It may be especially advantageous to incorporate such monomer groups non-uniformly into the polymer to form multiphase polymer particles to create a core-shell, hemispherical, or occluded morphology.

The aqueous dispersion of acrylic polymer particles imbibed with an epoxy compound (i.e., the imbibed latex) is advantageously prepared separately from the thermosettable compound using conventional emulsion polymerization techniques, then combined with the thermosettable compound, which can be neat or in the form of an aqueous emulsion, preferably as an aqueous emulsion, more preferably as a micronized aqueous emulsion. When the thermosettable compound is added as an aqueous emulsion, the emulsion is stabilized with a stabilizing amount of a surfactant, preferably at a concentration in the range of about 0.5 to about 10% by weight. Nonionic surfactants are preferred, including APEO free, non-ionic wetting agents such as polyalkylene oxide block copolymers, polyoxyethylene glycol alkyl ethers, glucoside alkyl ethers, fatty acid esters, glycerol alkyl esters, sorbitan alkyl esters, and polyoxyethylene glycol alkylphenol ethers, including commercially available wetting agents such as TRITON™ X-405 Octylphenol Ethoxylate (A trademark of The Dow Chemical Company or its Affiliates). When the thermosettable compound is combined with the latex as a neat compound, imbibing is facilitated by agitation at or above room temperature.

High solids content imbibed latexes, that is, latexes with solids content of at least 40 weight percent and particularly in the range of 45 to 60 weight percent, based on the total weight of the latex, can be used in the present invention.

The imbibed latex composition is useful as one part (i.e., binder component 1A or 2A) of a two-component formulation, the second component being a curing (i.e., crosslinking) component (1B or 2B) that is added prior to use that causes the thermosettable compound to cure or set. Accordingly, the binder component 1A and 2A of the present invention is substantially free of a curing agent; that is, there is insufficient concentration of a compound that promotes oxirane ring opening to destabilize the thermosettable compound. Preferably, the imbibed latex composition contains not more than 0.05 weight percent, more preferably not more than 0.005 weight percent, and most preferably 0 weight percent of a curing agent based on the total weight of the imbibed latex composition.

Preferably the imbibed latex in binder components 1A and 2A are cured with a water compatible external curing agent comprising the curing component 1B and 2B. Preferably, the imbibed latex is cured with a carboxylic acid-based acrylic. Examples of carboxylic acid-based acrylics include, for example, acrylic polymer emulsions comprising but not limited to structural units derived from carboxylic acids such as, for example, methacrylic acid, itaconic acid, and acrylic acid, and acrylic monomers including methyl acrylate, ethyl acrylate, butyl acrylate, hexyl acrylate, 2-ethylhexyl acrylate, octyl acrylate and isooctyl acrylate, n-decyl acrylate, isodecyl acrylate, tert-butyl acrylate, methyl methacrylate, butyl methacrylate, hexyl methacrylate, isobutyl methacrylate, isopropyl methacrylate, 2-hydroxyethyl acrylate, acrylamide, acrylonitrile, methacrylonitrile, isobornyl acrylate, n-propyl methacrylate, sec-butyl methacrylate, cyclohexyl methacrylate, t-butylaminoethyl methacrylate, stearyl methacrylate, glycidyl methacrylate, dicyclopentenyl methacrylate, phenyl methacrylate, and styrene. For example, the acrylic polymer dispersion may comprise a styrene-acrylic polymer.

Preferably, the acrylic polymer dispersions comprises 35 to 70 weight percent, and more preferably from 40 to 65 weight percent, of acrylic solids based on the total weight of the acrylic polymer dispersion. Preferably, the acrylic particles have an average weight particle size diameter in the range from 60 to 450 nm, and acid level in the range of from 0.1 to 15 weight percent of acid monomers based on the weight of the acrylic monomer, a weight average molecular weight in the range of from 50,000 to 5,000,000 g/mole, and a glass transition temperature (Tg) in the range of from 7 to 100° C. as measured by differential scanning calorimetry (DSC). The acrylic polymer dispersion preferably has a pH in the range of from 6 to 10.

The amount of curing agent used generally varies from about 1:1 to 4:1 epoxy to carboxylic acid stoichiometry based on moles of epoxide groups to moles of carboxylic acid. Preferably, the curing agent in curing component 1B in the first two-component coating composition is present in an amount from about 1.75:1 to 2.5:1 based on moles of epoxide groups to moles of carboxylic acid in the first two-component coating composition, and the curing agent in curing component 2B is present in the second two-component waterborne coating composition in an amount such that the stoichiometry between epoxy groups to acid groups ranges from 1:1 to 1.5:1 based on moles of epoxide groups to moles of carboxylic acid in the second two-component waterborne coating composition. More preferably, the curing agent in curing component 1B in the first two-component coating composition is present in an amount from about 2.0:1 to 2.5:1 based on moles of epoxide groups to moles of carboxylic acid in the first two-component coating composition, and the curing agent in curing component 2B is present in the second two-component waterborne coating composition in an amount such that the stoichiometry between epoxy groups to acid groups ranges from 1:2 to 1.4:1 based on moles of epoxide groups to moles of carboxylic acid in the second two-component waterborne coating composition.

Preferably, binder components 1A and 2A comprise similar acrylic latexes imbibed with an epoxy compound and the curing components 1B and 2B comprise a similar curing agent. In other words, the coating system preferably comprises a single-chemistry resin system.

The first and second two-component waterborne coating compositions further comprise a first and second coalescent package, respectively. Each coalescent package comprises at least one coalescent. As used herein, the term “coalescent” refers to non-volatile or slow-evaporating solvents that fuse polymer particles into a continuous film under ambient conditions. The at least one coalescent contained in each of the coalescent packages may the same or different. Preferably, the first and second coalescent packages comprise the same coalescents.

Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include dipropylene glycol n-butyl ether, ethylene glycol monobutyl ether, diethylene glycol monobutyl ether, n-butyl ether, or mixtures thereof. Commercially available coalescents include, for example, OPTIFILM 400 and TEXANOL Coalescent, both available from The Eastman Chemical Company.

Preferably, the second coalescent package comprises a lower amount of coalescent than the first coalescent package. The at least one coalescent in the first coalescent package is present in an amount ranging from 10 to 30 weight percent, preferably from 15 to 25 weight percent, based on a total weight of solids in the first binder component 1A and first curing component 1B, where the total solids amount does not include any additional components (e.g., pigment present in the first two-component coating composition). The at least one coalescent in the second coalescent package is present in an amount ranging from 2 to 10 weight percent, preferably 4 to 9 weight percent, based on a total weight of solids in the second binder component 2A and second curing component 2B, where the total solids amount does not include any additional components (e.g., pigment present in the second two-component coating composition).

The first and second two-component coating compositions have differing minimum film formation temperatures (MFFT). The MFFT is the lowest temperature at which the polymer particles on the aqueous dispersion will mutually coalesce and form a continuous film when the volatile component (e.g., water) evaporates. The MFFT can be measured in accordance with GB/T 9267-2008. The first two-component coating composition is less than 5° C. Preferably, the MFFT of the first two-component coating composition ranges from −10° C. to 5° C. The second two-component coating composition has an MFFT from 5° C. to 25° C., preferably from 5° C. to 15° C.

The first and second two-component coating compositions according to the present invention may further include one or more of the following additives: solvents; fillers; pigments, such as titanium dioxide, mica, calcium carbonate, silica, zinc oxide, milled glass, aluminum trihydrate, talc, antimony trioxide, fly ash, and clay; polymer encapsulated pigments, such as polymer-encapsulated or partially encapsulated titanium dioxide, zinc oxide, or lithopone; polymers or polymer emulsions adsorbing or bonding to the surface of pigments such as titanium dioxide; hollow pigments, including pigments having one or more voids; dispersants, such as aminoalcohols and polycarboxylates; surfactants; defoamers; preservatives, such as biocides, mildewcides, fungicides, algaecides, and combinations thereof; flow agents; leveling agents; and additional neutralizing agents, such as hydroxides, amines, ammonia, and carbonates.

The volatile organic compound (VOC) content of the first and second two-component coating compositions may also differ. For example, the VOC content of the first two-component coating composition may range from 0.75 to 1.25 lb/gal, and the VOC content of the second two-component coating composition may range from 0.25 to 0.5 lb/gal.

Likewise the pigment volume concentration (PVC) of the first and second two-component coating compositions may differ. The PVC may be calculated by the following equation:

$$PVC = \frac{( Volume of Pigment )}{( Volume of Pigment + Volume of Dry Latex )}$$

For example, the PVC of the first two-component coating composition may range from 15 to 20%, and the PVC of the second two-component coating composition may range from 7.5 to 12.5%.

A Second aspect of the present invention relates to a method of preparing a coating. The method comprises providing first and second waterborne coating compositions, as described above.

A first coating layer is formed by applying the first two-part coating composition to a substrate. The first coating layer is at least partially cured at a temperature greater than room temperature for at least 10 minutes. Preferably, the curing temperature is at least 50° C. and more preferably at least 60° C., and the curing time is preferably at least 15 minutes. Prior to curing, the first layer may be flashed at room temperature.

After the first coating layer is at least partially cured, a second layer is applied with the second two-component coating composition on the first layer. The second layer is then cured at a temperature greater than room temperature for at least 10 minutes. Preferably, the curing temperature is at least 50° C., more preferably at least 60° C., and the curing time is preferably at least 15 minutes. The second layer may be flashed at room temperature prior to curing to allow volatile components to evaporate.

Preferably the substrate is a metal substrate. The metal substrate may be either bare metal (e.g., the coating is a direct-to-metal coating) or a primed metal substrate (e.g., a metal substrate primed with a zinc-rich primer).

### EXAMPLES

The following examples are for illustrative purposes only and are not intended to limit the scope of the invention. The following materials are used in the examples:

AEH-1 is an AEH dispersion having a solids content of 53.9%, an epoxy equivalent weight of 312 g/eq based on weight solids and a pH of 7.

AEH-2 is an AEH dispersion having a solids content of 52.2%, an epoxy equivalent weight of 468 g/eq based on weight solids and a pH of 7.

SAP is a carboxylic-acid functional styrene-acrylic polymer dispersion with a solids content of 49.5% and an acid equivalent weight of 2457 g/eq on polymer solids and is used as a curing agent.

DOWANOL™ DPnB is a dipropylene glycol mono n-butyl ether available from The Dow Chemical Company and is used as a coalescent.

OPTIFILM 400 is a coalescent available from Eastman Chemical Company.

OROTAN™ 681 is a polymethacrylic acid with hydrophobic comonomers available from The Dow Chemical Company and is used as a dispersant.

ACRYSOL™ RM-12W is a nonionic urethane rheology modifier available from The Dow Chemical Company.

TEGO Airex 902W is a polyether siloxane copolymer emulsion available from Evonik Corporation and is used as a defoamer.

Ti-PURE R-706 is a titanium dioxide pigment available from The Chemours Company.

TAMOL™ 681 is a hydrophobic copolymer dispersant available from The Dow Chemical Company.

TRITON™ HW-1000 is a nonionic surfactant available from The Dow Chemical Company.

ANCAMINE K-54 is a tris-(dimethylaminomethyl) phenol curing agent available from Evonik Corporation.

XIAMETER™ OFS-6020 is an aminoethylaminopropyl trimethoxysilane coupling agent available from The Dow Chemical Company.

### Preparation of Base Coat Compositions

The pigment grind for Base 1, Base 2, and the Topcoat was prepared according to Table 1 below. The following ingredients were added to 1 L stainless steel container and mixed at low shear (1000 rpm) on a dispersator with a 2″ cowles blade until uniform (~5 min): 299.56 g deionized water, 11.68 g Ammonia (28%), 7.49 g Foamex 1488, 48.13 g Tamol 681, and 9.99 g Triton HW1000. After approximately 5 minutes, 1123.15 g of TiPure R706 was added slowly under shear. Mixing speed was increased gradually to achieve a good vortex. After all of the TiO2 was added, the dispersator was stopped so that the blade, shaft, and sides of container could be scraped with a metal spatula. The dispersator was then turned on and the speed was increased to ~2000 rpm. Mixing was complete after approximately 15 min when the Hegman gauge read 7-8 units. The pigment grind was then ready to be added to formulation in Table 2 as listed below.

TABLE 1

| | Weight |
|---|---|
| Component | (grams) |
| Deionized Water | 499.27 |
| Ammonia (28%) | 19.47 |
| TEGO Foamex 1488 | 12.48 |
| TAMOL ™ 681 | 80.22 |
| TRITON ™ HW1000 | 16.64 |
| Ti-Pure R-706 TiO2 | 1871.91 |
| Total | 2500 |

Two base coat compositions, Base 1 and Base 2, were prepared using two different acrylic epoxy hybrids, AEH-1 and AEH-2, respectively. Part B side mixtures were prepared in a plastic container of appropriate size for contents (8 oz. to 32 oz.) using a metal paddle blade (1″ diameter) on a lab mixer set to an appropriate speed (500-1000 rpm) to maintain a good vortex. The first ingredient was added on a lab balance, whereas additional ingredients were added while mixing to enable good incorporation. After last ingredient was added, the mixture was allowed to mix for an additional 15 minutes at ~1100 rpm. Part B sides were allowed to equilibrate overnight before mixing together with a tongue depressor and making a coating.

TABLE 2

| | Base 1 | Base 2 | Topcoat |
|---|---|---|---|
| Component | Wt (grams) | Wt (grams) | Wt (grams) |
| Part A | | | |
| AEH-1 (53.9%) | 6.35 | — | — |
| AEH-2 (52.2%) | — | 9.07 | 6.76 |
| Part B | | | |
| SAP (49.5%) | 23.57 | 22.87 | 30.25 |
| ANCAMINE K-54 | 0.13 | — | 0.16 |
| TEGO Airex 902W | 1.69 | 1.77 | 1.70 |
| Pigment Grind | 17.02 | 17.76 | 10.74 |
| (shown in Table 1) | | | |
| DOWANOL ™ DPnB | 2.18 | 2.31 | 0.74 |
| OPTIFILM 400 | 0.79 | 0.84 | 0.37 |
| Sodium Nitrite 15% | 0.49 | 0.52 | 0.53 |
| TRITON ™ HW-100 | — | — | 0.05 |
| XIAMETER ™ OFS-6020 | 0.22 | 0.22 | 0.10 |
| Deionized Water | 3.80 | 3.55 | 5.18 |
| ACRYSOL ™ RM-12W | 0.11 | 0.17 | 0.18 |
| Total Part B | 50 | 50 | 50 |
| Total Mixed | 56.35 | 59.07 | 56.76 |

The properties for Base 1, Base 2, and the Topcoat are shown in Table 3.

TABLE 3

| | Base 1 | Base 2 | Topcoat |
|---|---|---|---|
| Properties | Value | Value | Value |
| Molar Ratio | 2.3/1 | 2.3/1 | 1.3/1 |
| (epoxy/acid) | | | |
| % PVC | 17.0 | 17.0 | 10.0 |
| VOC (lb/gal) | 0.91 | 0.91 | 0.33 |
| % Wt Solids | 52.8 | 52.9 | 49.2 |
| % Vol Solids | 40.9 | 40.9 | 40.8 |
| % Coalescent | 19.7 | 19.6 | 6.0 |

### 2-Layer Coated Metal Samples

Samples were prepared by coating an iron phosphate (BONDERITE 1000) cold rolled steel substrate with a two-layer coating. In Example 1, a first coat of Base 1 was applied, followed by a coating of Topcoat. Example 2 was prepared by coating the substrate with a first layer of Base 2 and a second layer of Topcoat. Comparative Example 1 was prepared by coating the substrate with a first layer of Base 2 and a second layer of Base 1. To prepare Comparative Example 2, two layers of Topcoat were applied. In each of the 2-layer coating samples, the first layer was applied and flashed off at room temperature for 30 minutes and then cured at 80° C. for 20 minutes. The sample was then allowed to cool for 1 to 2 hours until it reached room temperature before the second layer was applied. The second coating was flashed off at room temperature for 30 minutes and then cured at 80° C. for 20 minutes. After curing, the coated metal samples were kept at room temperature for 7 days before testing.

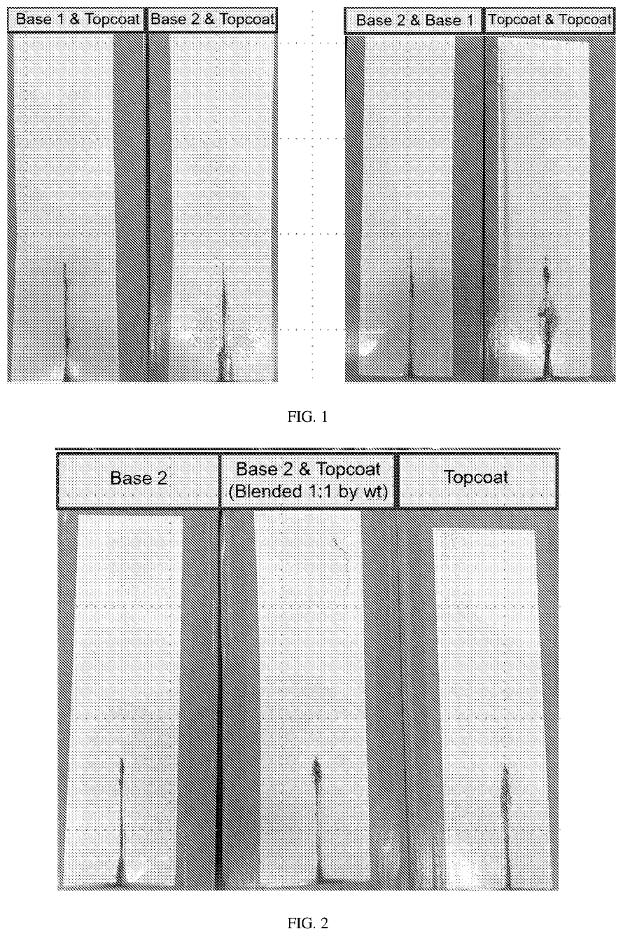

Corrosion resistance of the samples was determined by subjecting the samples to salt spray for 504 hours followed by scraping. As shown in FIG. 1, Examples 1 and 2 and Comparative Example 1 exhibited good corrosion resistance, while Comparative Example 2, which consisted of 2 layers of Topcoat exhibited poor corrosion resistance.

A Persoz pendulum was used to test the hardness of each of the coated metal samples following ASTM-D4366. The results for the Persoz hardness testing is shown below in Table 4, which also shows that each sample had a relatively similar thickness and gloss, as tested by micro-TRI-gloss machine (BYK Company). The hardness of Examples 1 and 2 was significantly improved compared to the 2-layer coating of Comparative Example 1, which lacked a layer comprising Topcoat.

TABLE 4

| | Dry Film | | |
|---|---|---|---|
| | Thickness | Persoz | |
| Sample | (μm) | (sec) | 60° Gloss |
| Example 1 | 56 | 86 | 74 |
| Example 2 | 60 | 74 | 84 |
| Comparative | 58 | 46 | 81 |
| Example 1 | | | |
| Comparative | 58 | 119 | 83 |
| Example 2 | | | |

### Single-Layer Coated Metal Samples

Single-layer coated metal samples were prepared on iron phosphate (BONDERITE 1000) coated cold rolled steel substrates. Comparative Example 3 was prepared by coating Base 2 on the metal substrate. Comparative Example 4 was prepared by blending 1:1 by Base 2 and Topcoat and formed the coating as a single layer on the substrate. Comparative Example 5 was prepared by coating the metal substrate with a single layer of Topcoat. Each sample was prepared by coating a single layer on the substrate and flashing off for 30 minutes at room temperature and curing at 80° C. for 20 minutes, followed by 7 days at room temperature before testing.

Corrosion tests and hardness tests were repeated for the single-layer coated metal samples. For the corrosion test, the samples were exposed to salt spray for 552 hours before being scraped. As shown in FIG. 2, Comparative Examples 4 and 5 both exhibited poor corrosion resistance in contrast to Comparative Example 3. The results of the hardness testing is shown below in Table 5.

TABLE 5

| | Dry Film | | |
|---|---|---|---|
| | Thickness | Persoz | |
| Sample | (μm) | (sec) | 60° Gloss |
| Comparative | 74 | 31 | 78 |
| Example 3 | | | |
| Comparative | 78 | 43 | 84 |
| Example 4 | | | |
| Comparative | 79 | 87 | 87 |
| Example 5 | | | |

Although Comparative Example 4 exhibited slightly better hardness than Comparative Example 3, the hardness of Comparative Example 4 was significantly lower than the 2-layer coated metal sample of Example 2.

A direct comparison of Example 2 and Comparative Example 4 clearly demonstrates that using different formulations in 2 separate layers with at least partial curing between each layer can significantly improve both the corrosion resistance and hardness of the resulting coating.

1. A coating system comprising:
a) a first two-component waterborne coating composition comprising a binder component 1A and a curing component 1B, wherein the binder component 1A comprises a first aqueous dispersion of acrylic polymer particles imbibed with an epoxy compound, wherein the first two-component waterborne coating composition comprises a first coalescent package comprising at least one coalescent and has a minimum film formation temperature (MFFT) less than 5° C.;
b) a second two-component coating composition comprising a binder component 2A and a curing component 2B, wherein the binder component 2A comprises a second aqueous dispersion of acrylic polymer particles imbibed with an epoxy compound, wherein the second two-component waterborne coating composition comprises a second coalescent package comprising at least one coalescent and has MFFT from 5° C. to 25° C.

2. The coating system of claim 1, wherein the first aqueous dispersion of acrylic polymer particles imbibed with an epoxy compound is the same as the second aqueous dispersion of acrylic polymer particles imbibed with an epoxy compound.

3. The coating system of claim 1, wherein the curing component 1B and the curing component 2B are selected from carboxylic acid-based acrylic curing agents.

4. The coating system of claim 3, wherein the curing component 1B is present in the first two-component waterborne coating composition in an amount such that the molar ratio of epoxy groups to carboxylic acid groups ranges from 1.75:1 to 4:1 in the first two-component waterborne coating composition, and the curing component 2B is present in the second two-component waterborne coating composition in an amount such that the molar ratio of epoxy groups to carboxylic acid groups ranges from 1:1 to 1.5:1 in the second two-component waterborne coating composition.

5. The coating system of claim 1, wherein the curing component 1B is the same as the curing component 2B.

6. The coating system of claim 1, wherein the first coalescent package is present in an amount comprising 10 to 30 wt % based on a total weight of solids in the first binder component 1A and the first curing component 1B in the first two-component coating composition, and the second coalescent package is present in an amount comprising 2 to 10 wt % based on a total weight of solids in the second binder component 2A and the second curing component 2B in the second two-component coating composition.

7. The coating system of claim 6, wherein the first coalescent package is present in an amount comprising 15 to 25 wt % based on a total weight of solids in the first binder component 1A and the first curing component 1B in the first two-component coating composition, and the second coalescent package is present in an amount comprising 4 to 9 wt % based on a total weight of solids in the second binder component 2A and the second curing component 2B in the second two-component coating composition.

8. The coating system of claim 1, wherein the second two-component coating composition has a MFFT from 5° C. to 15° C.

9. The coating system of claim 1, wherein the first two-component coating composition has a VOC content ranging from 0.75 to 1.25 lb/gal, and the second two-component coating composition has a VOC content ranging from 0.25 to 0.5 lb/gal.

10. The coating system of any one of the preceding claims, wherein the first two-component coating composition has a pigment volume concentration (PVC) of 15 to 20%, and the second two-component coating composition has a PVC of 7.5 to 12.5%.

11. A method of preparing a coating comprising:
(i) applying the first two-part coating composition of claim 1 to a substrate to form a first coating layer;
(ii) at least partially curing the first coating layer at a temperature greater than room temperature for at least 10 minutes;
(iii) applying the second two-part coating composition on the first coating layer to form a second coating layer;
(iv) curing the second coating layer to form a two-layer coating on the substrate at a temperature greater than room temperature for at least 10 minutes.

12. The method of claim 11, wherein the substrate comprises a metal substrate.

13. The method of claim 12, wherein the metal substrate comprises a bare metal substrate or a primed metal substrate.

14. The method of any one of claim 11, wherein in step (iii) the first coating layer is at least partially cured at a temperature of at least 50° C. for at least 15 minutes.

15. The method of claim 11, wherein in step (iv) the second coating layer is cured at a temperature of at least 50° C. for at least 15 minutes.
